(19) United States
(12) Patent Application Publication
(10) Pub. No.: US 2005/0073995 A1
(43) Pub. Date: Apr. 7, 2005

(54) Voice-over-internet protocol device

(75) Inventors: Ching-Mao Yeh, Hsinchu (TW); An-Pang Chang, Hsinchu (TW)

Correspondence Address: LADAS & PARRY, 5670 WILSHIRE BOULEVARD, SUITE 2100, LOS ANGELES, CA, 90036-5679, US

(73) Assignee: Ambit Microsystems Corporation

(21) Appl. No.: 10/615,167

(22) Filed: Jul. 7, 2003

(30) Foreign Application Priority Data
Sep. 17, 2002 (TW) 91121268

(51) Int. Cl. H04L 12/66

(52) U.S. Cl. 370/352; 370/463

(57) ABSTRACT

A VoIP device comprises a subscriber line interface circuit, a relay, a processor, and a dual-tone multi-frequency (DTMF) coupling circuit. The relay is selectively coupled to a PSTN (Public Switched Telephone Network) or coupled to a VoIP network through the subscriber line interface circuit. The processor determines whether a transmission from the telephone through the subscriber line interface circuit is a PSTN phone number or a VoIP phone number. When the transmission is a VoIP phone number, the processor routes the transmission to the VoIP network. When the transmission is a PSTN phone number, the processor instructs the subscriber line interface circuit to generate a DTMF redial number. The DTMF coupling circuit receives the DTMF redial number and routes the DTMF redial number to the PSTN network.

### BACKGROUND OF THE INVENTION

1. Field of the Invention

The invention relates to an application for telephone communication service, and in particular, to a VoIP (Voice-over-Internet Protocol) device that also supports POTS (Plain Old telephone service) public switched telephone networking (PSTN) at the same time.

2. Description of the Related Art

Several communication technologies provide different telephone communication services. Telephone communication services comprise POTS and VoIP (Voice-over-Internet Protocol) service. POTS is popular for standard telephone communications. When one telephone is coupled to the PSTN (public switched telephone network), the user of the telephone is served by POTS. VoIP is a protocol for transmitting voice and image packets through an open network to provide telephone communication service. The benefit of VoIP service is that subscribers can pay a local dial-up fee and achieve long distance call service via Internet access when a call agent exists in the service, and thereby reduce telephone fees. The drawback is that the communication quality is not stable. If Internet service or a call agent is not available or system noise is prohibitive, for example, communication quality is compromised. Telephone fees for POTS are much higher than VoIP service, but the communication quality is more stable in the network environment today.

Products providing telephone communication service on the market cannot support POTS and VoIP service at the same time, such that users must provide a separate dedicated telephone system for each protocol, presenting considerable inconvenience.

### SUMMARY OF THE INVENTION

An object of the present invention is to provide a VoIP device that also supports POTS at the same time. A single telephone system can provide VoIP service and PSTN service when the VoIP service is unavailable. Users can set specific telephone numbers for transmission through PSTN networks only. Telephone fees are thus reduced and convenience is increased.

The VoIP device comprises a subscriber line interface circuit, a relay, a processor, and a dual-tone multi-frequency coupling circuit. The subscriber line interface circuit is coupled to a telephone and serves as an interface for communications with the telephone. The relay is selectively coupled to a PSTN or a VoIP network through the subscriber line interface circuit. The processor is coupled to the subscriber line interface circuit to determine whether a transmission from the telephone through the subscriber line interface circuit is a PSTN phone number or a VoIP phone number. When the transmission is a VoIP phone number, the processor routes the transmission to the VoIP network. When the transmission is a PSTN phone number, the processor instructs the subscriber line interface circuit to generate a dual-tone multi-frequency redial number. The dual-tone multi-frequency coupling circuit receives the dual-tone multi-frequency redial number from the subscriber line interface circuit and couples the dual-tone multi-frequency redial number to the public switched telephone network.

The dual-tone multi-frequency coupling circuit comprises a switching element, a first coupling device, and a second coupling device. The switching element has a first terminal and a second terminal and is controlled by the processor. When the transmission is a PSTN phone number, the processor turns on the switching element. The first coupling device is coupled between the subscriber line interface circuit and the first terminal of the switching element. The first coupling device is used to receive the dual-tone multi-frequency redial number from the subscriber line interface circuit. The second coupling device is coupled between the second terminal of the switching element and the public switched telephone network. The second coupling device is used to couple the dual-tone multi-frequency redial number to the PSTN when the switching element is turned on.

### DESCRIPTION OF THE DRAWINGS

For a better understanding of the present invention, reference is made to a detailed description to be read in conjunction with the accompanying drawings, in which:

FIG. 1 is a block diagram illustrating a VoIP device according to the invention; and

FIG. 2 is a circuit diagram illustrating the dual-tone multi-frequency coupling circuit in the present invention.

### DETAILED DESCRIPTION OF THE INVENTION

The invention discloses a VoIP (Voice-over-Internet Protocol) device that also supports POTS (Plain Old Telephone Service) at the same time. Users can use one telephone to make a VoIP call and make a PSTN call when VoIP service is unavailable. Users can also set specific telephone numbers as PSTN phone numbers to be routed through the PSTN network. Accordingly, telephone fees are reduced and the convenience is increased. The following embodiment is described in detail with reference to the figures.

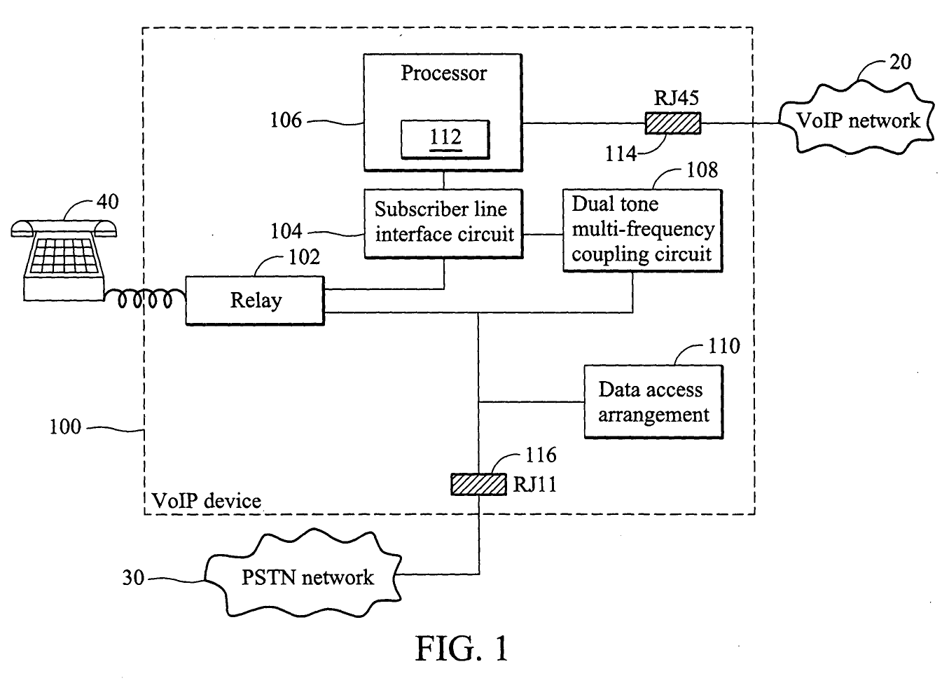

FIG. 1 is a block diagram illustrating a VoIP (Voice-over-Internet Protocol) device according to the embodiment of the invention. As shown in FIG. 1, the VoIP device 100 comprises a relay 102, a subscriber line interface circuit 104, a processor 106, a dual-tone multi-frequency (DTMF) routing circuit 108 and a data access arrangement (DAA) 110. The VoIP device 100 is connected to a VoIP network 20 through a RJ45 plug 114. The VoIP device 100 is connected to a PSTN (Public Switched Telephone Network) 30 through a RJ11 plug 116.

The subscriber line interface circuit 104 is an interface between analog telephone signals of a telephone 40 and digital signals of the VoIP device 100. The relay 102 is selectively coupled to the PSTN network 30 or coupled to the VoIP network 20 through the subscriber line interface circuit 104. In the embodiment, the VoIP device 100 is set to a VoIP mode by default. When the VoIP device 100 accesses the Internet and detects a call agent, the telephone 40 is coupled to the VoIP network 20 through the relay 102. Then, the user of the VoIP device 100 can obtain VoIP service and make a VoIP call. When VoIP device 100 cannot access the Internet or is not served by the VoIP network 20, the telephone 40 is coupled to the PSTN network 30 through the relay 102. Then, the user can make a PSTN call using the same telephone 40. The VoIP device 100 automatically detects the status of the VoIP network 20 to switch the relay 102. The user can also switch the relay 102 manually through other software or hardware means.

The processor 106 is coupled to the subscriber line interface circuit 104 to determine whether a transmission from the telephone 40 is a PSTN phone number or a VoIP phone number. The rule for determination is set and stored into the processor by the user in advance. For example, the user can set common telephone numbers as VoIP phone numbers and important and emergency telephone numbers as PSTN phone numbers.

When the transmission is determined as a VoIP phone number, the processor 106 processes the VoIP phone number by the digital signal processor 112 and routes the transmission to the VoIP network 20. When the transmission is determined as a PSTN phone number, the processor 106 instructs the subscriber line interface circuit 104 to generate a dual-tone multi-frequency (DTMF) redial number. A DTMF coupling circuit 108 is coupled between the subscriber line interface circuit 104 and the PSTN network 30. When the transmission is determined as a PSTN phone number, the DTMF coupling circuit 108 couples the DTMF redial number from the subscriber line interface circuit 104 and couples the DTMF redial number to the PSTN network 30.

Meanwhile, the DAA 110 detects the status of the PSTN network 30, such as incoming ringing event or off-the-hook status, and instructs the relay 102 for allowing the DTMF coupling circuit 108 to transmit the DTMF redial number to the PSTN network 30 when the PSTN network 30 is not busy.

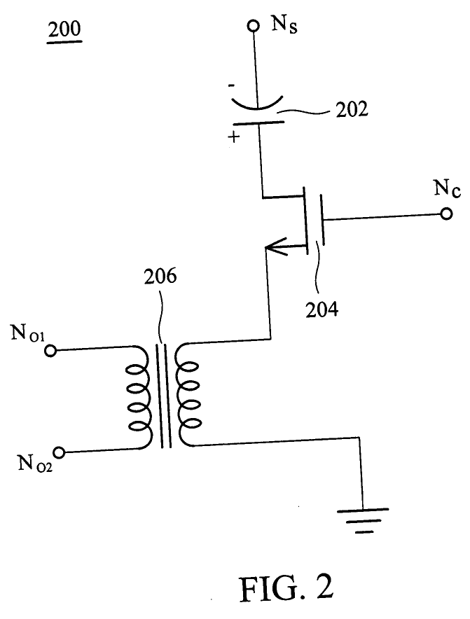

FIG. 2 is a circuit diagram illustrating the dual-tone multi-frequency (DTMF) coupling circuit in the embodiment of the present invention. The DTMF coupling circuit 200 shown in FIG. 2 is an example of the DTMF coupling circuit 108 shown in FIG. 1. The DTMF coupling circuit 200 comprises a capacitor 202, a NMOS transistor 204 and a transformer 206. The anode of the capacitor 202 is connected to a drain of the NMOS transistor 204. The cathode of the capacitor 202 Nₛ is connected to the subscriber line interface circuit 104 (not shown in FIG. 2) for coupling and/or decoupling the subscriber line interface circuit 104. The NMOS transistor 204 is a switch in the DTMF coupling circuit 200. A gate N_{c} of the NMOS transistor 204 is connected to the processor 106 (not shown in FIG. 2). The processor 106 of FIG. 1 drives the voltage of the gate N_{c} to switch the status of the NMOS transistor 204, i.e. turn the NMOS transistor 204 on or off. The transformer 206 is connected between a source of the NMOS transistor 204 and the PSTN network 30 (not shown in FIG. 2) for coupling and decoupling the PSTN network 30.

The capacitor 202 receives the DTMF redial number from the subscriber line interface circuit 104 (referring to FIG. 1). When the processor 106 of FIG. 1 determines that a transmission from the telephone is a PSTN number, the NMOS transistor 204 is turned on. The transformer 206 sends the DTMF redial number to the PSTN network.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). The dual-tone multi-frequency coupling circuit of the FIG. 2 is taken as an example. Other coupling devices, such as optical coupling elements, can replace the capacitor and the transformer in FIG. 2. Other switching elements can replace the NMOS transistor in FIG. 2. Therefore, the scope of the appended claims should be accorded with the broadest interpretation so as to encompass all such modifications and similar arrangements.

1. A voice-over-Internet protocol (VoIP) device, comprising:
a subscriber line interface circuit serving as an interface for communications with a telephone;
a relay selectively coupled to a public switched telephone network (PSTN) or coupled to a VoIP network through the subscriber line interface circuit;
a processor coupled to the subscriber line interface circuit to determine whether a transmission from the telephone through the subscriber line interface circuit is a PSTN phone number or a VoIP phone number, wherein when the transmission is a VoIP phone number, the processor routes the transmission to the VoIP network, and when the transmission is a PSTN phone number, the processor instructs the subscriber line interface circuit to generate a dual-tone multi-frequency redial number; and
a dual-tone multi-frequency coupling circuit coupled between the subscriber line interface circuit and the public switched telephone network for receiving the dual-tone multi-frequency redial number from the subscriber line interface circuit when the transmission is determined as a PSTN phone number, and routing the dual-tone multi-frequency redial number to the public switched telephone network.

2. The voice-over-Internet protocol device of claim 1, wherein the dual-tone multi-frequency coupling circuit comprises:
a switching element having a first terminal and a second terminal and controlled by the processor, wherein the switching element is turned on by the processor when the transmission is determined as a PSTN phone number;
a first coupling device coupled between the subscriber line interface circuit and the first terminal of the switching element for receiving the dual-tone multi-frequency redial number from the subscriber line interface circuit; and
a second coupling device coupled between the second terminal of the switching element and the public switched telephone network for routing the dual-tone multi-frequency redial number to the public switched telephone network when the switching element is turned on.

3. The voice-over-Internet protocol device of claim 2, wherein the first coupling device is a capacitor.

4. The voice-over-Internet protocol device of claim 2, wherein the second coupling device is a transformer.

5. The voice-over-Internet protocol device of claim 2, wherein the switching element is a transistor.

6. The voice-over-Internet protocol device of claim 1, further comprising a data access arrangement for detecting the status of the public switched telephone network and instructing the relay to allow the dual-tone multi-frequency coupling circuit to transmit the dual-tone multi-frequency redial number to the public switched telephone network when the public switched telephone network is not busy.
